(19) United States
(12) Patent Application Publication
(10) Pub. No.: US 2010/0153491 A1
(43) Pub. Date: Jun. 17, 2010

(54) Method, System And Client Terminal For Sending Data In Instant Messaging System

(75) Inventor: Bin Li, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/645,177

(22) Filed: Dec. 22, 2009

Related U.S. Application Data
(63) Continuation of application No. PCT/CN2008/070609, filed on Mar. 27, 2008.

(30) Foreign Application Priority Data
Jun. 29, 2007 (CN) 200710076339.X

(51) Int. Cl. G06F 15/16

(52) U.S. Cl. 709/203; 709/206

(57) ABSTRACT

Embodiments of the present disclosure provide a method, a system and a client terminal for sending data in an IM system, which belong to computer technologies. The method includes: sending an Email carrying a large amount of data of a first user to an offline second user; sending an offline message to the second user, the offline message carrying information of the first user and an identifier of the Email, with which the second user obtains the large amount of data. The system includes a client terminal of a first user and a client terminal of a second user. By adopting embodiments of the present disclosure, a large amount of data sent by the user, such as offline documents or offline voice information, etc, may be received in an IM system.

### CROSS-REFERENCE TO RELATED APPLICATIONS

This application is a continuation of International Application No. PCT/CN2008/070609, filed on Mar. 27, 2008, which claims priority to Chinese Application No. CN 200710076339.X, filed on Jun. 29, 2007. The entire disclosures of each of the above applications are incorporated herein by reference.

### FIELD

The present disclosure relates to computer technologies, and more particularly, to a method, system and client terminal for sending data in an Instant Messaging (IM) system.

### BACKGROUND

This section provides background information related to the present disclosure which is not necessarily prior art.

An Email system is the earliest network application. An Email user may perform non-real time transmission for data and information via an Email address provided by a server. Generally, the user may finish the communication via sending an Email. However, the non-real-time characteristics of the communication cannot satisfy real-time requirements of the users. Therefore, a network Instant Messaging tool, i.e. Instant Messaging (IM) software, emerges, for sending real-time data and information among users.

With the development of network technologies, having been developed until today, the IM has been accepted by most Net-surfers, and has become an indispensable part of people's working and life. The instant messaging tool also has become an indispensable software tool for the users. The users perform daily exchange and communication in the network by the IM software, and adopt the IM software to perform real-time transmission of ordinary text messages, data documents, voice messages, and so on. The real-time communication has been widely used not only in daily entertainments, but also in people's working. Along with the wide use of the network instant messaging tool, the users have put forward higher requirements for usability of the IM software. Because the IM application is a kind of real-time exchange and communication mode, it requires the users to perform communication. When a user is offline, other users may send offline messages to the user, and the user may obtain the offline messages after logging on. All of the current IM software supports the transmission of a small amount of text offline messages. That is, the IM server may temporarily store the ordinary text messages sent by other users to the offline user, and send the stored text messages to the user when the user logs on again. However, the current IM server still cannot send a large amount of data documents or voice messages to offline users.

### SUMMARY

This section provides a general summary of the disclosure, and is not a comprehensive disclosure of its full scope or all of its features.

Embodiments of the present disclosure provide a method, a system and a client terminal for sending data in an Instant Messaging (IM) system, so that the offline users is also able to receive data documents or voice information sent from other users.

In the embodiments of the present disclosure, a large amount of data to be transmitted by a user is sent to an offline contact in the form of an Email, meanwhile an offline message carrying user information and an identifier of the Email is also sent to the offline contact. When the offline contact is logging on, the contact may extract the user information and the identifier of the Email by analyzing the received offline message, receive the corresponding Email according to the user information, and extract the data from the Email, thus the transmission of a large amount of offline data may be implemented. The technical solution is as follows.

An embodiment of the present disclosure provides a method for sending data in an IM system, including:

sending an Email carrying a large amount of data of a first user to an offline second user;

sending an offline message to the second user, the offline message carrying information of the first user and an identifier of the Email, with which the second user obtains the large amount of data.

An embodiment of the present disclosure provides a method for receiving data in an IM system, including:

receiving, by an online first user, an offline message from a second user, the offline message carrying information of the second user and an identifier of an Email carrying a large amount of data;

receiving the Email according to the information of the second user and the identifier of the Email carried in the offline message, and

receiving the large amount of data from the Email.

An embodiment of the present disclosure also provides a user client terminal, including:

an Email sending module, configured to send an Email carrying a large amount of data of a first user to an offline second user; and

an offline message sending module, configured to send an offline message when the Email sending module is sending the Email, the offline message carrying information of the first user and an identifier of the Email, with which the second user obtains the large amount of data.

An embodiment of the present disclosure provides a contact client terminal, including:

an offline message receiving module, configured to receive an offline message after a first user client terminal logs on, the offline message carrying information of a second user and an identifier of an Email carrying a large amount of data; and

an Email obtaining module, configured to receive the offline message sent by the offline message receiving module, receive the Email carrying the large amount of data according to the information of the second user and an identifier of the Email carried in the offline message, and receive the large amount of data.

An embodiment of the present disclosure provides an IM system, including:

a client terminal of a first user, configured to send an Email carrying a large amount of data to an offline second user, and send an offline message to the second user, the offline message carrying information of the first user and an identifier of the Email; and

a client terminal of the second user, configured to receive the offline message from the client terminal of the first user when the second user logs on, and receive the Email according to the information of the first user and the identifier of the Email carried in the offline message.

An embodiment of the present disclosure provides an IM method, including:

sending, by a client terminal of a first user, an Email carrying a large amount of data to an offline second user, and sending an offline message to the second user, the offline message carrying information of the first user and an identifier of the Email; and

receiving, by a client terminal of the second user, the offline message from the first user client terminal when the second user logs on, and receiving the Email according to the information of the first user and the identifier of the Email carried in the offline message.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating structure of an IM System for transmitting an offline message in accordance with a first an embodiment of the present disclosure;

FIG. 2 is a flow chart illustrating a method for sending an offline message by an IM system in accordance with a second embodiment of the present disclosure; and

FIG. 3 is a flow chart illustrating a method for sending an offline message by an IM system in accordance with a third embodiment of the present disclosure.

Corresponding reference numerals indicate corresponding parts throughout the several views of the drawings.

### DETAILED DESCRIPTION

Example embodiments will now be described more fully with reference to the accompanying drawings.

Reference throughout the specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

To make objectives, technical solutions and advantages of the present disclosure clearer, detailed descriptions for the embodiments of the present disclosure are further provided hereinafter accompanying with drawings. However, the present disclosure is not limited to the following embodiments.

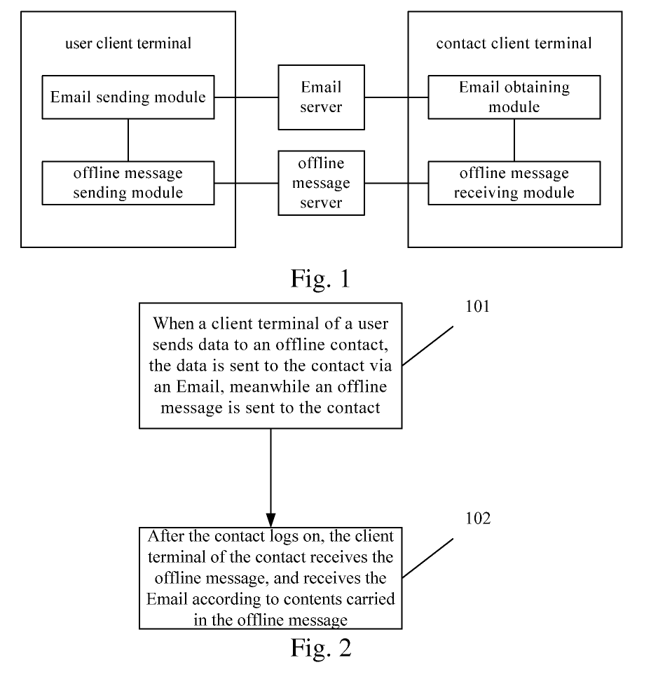

With reference to FIG. 1, the embodiment of the present disclosure provides an IM system for sending an offline message. The system includes a user client terminal, a contact client terminal, an Email server and an offline message server. The specific structure of each component is as follows.

The user client terminal includes an Email sending module and an offline message sending module.

The Email sending module is configured to send data to the Email server via an Email, when a user sends a large amount of data to an offline contact.

According to common knowledge in the industry, a large amount of data refers to data of at least 1 k.

Specifically speaking, the Email sending module includes an Email generating unit and an Email sending unit.

The Email generating unit is configured to obtain an Email address and a password of the user according to user information, obtain an Email address of a contact according to contact information, generate an Email taking the Email address of the user as an addresser, taking the Email address of the contact as an addressee, and taking the data as an attachment, and send the Email to the Email sending unit. When the data is a text document, the data may be written into the body of the Email, or may be taken as the attachment of the Email. When the data is a multimedia document, the multimedia document may be taken as attachment of the Email.

The Email sending unit is configured to send the Email to the Email server according to the Email address and the password obtained by the Email generating unit.

The offline message sending module is configured to send an offline message to the offline message server. The offline message carries the user information and an identifier of the Email.

Specifically speaking, the user information may be the User Identification Number (UIN) of the user.

The contact client terminal includes an offline message receiving module and an Email obtaining module.

The offline message receiving module is configured to receive the offline message from the offline message server after the contact logs on, and send contents of the offline message to the Email obtaining module.

The offline message includes the user information (e.g., UIN), and the identifier of the Email (e.g., a name or serial number of the attachment).

The Email obtaining module is configured to receive the offline message sent by the offline message receiving module, receive the Email from the Email server according to the contents of the offline message.

Specifically speaking, the Email obtaining module includes an address and password obtaining unit and an Email obtaining unit.

The address and password obtaining unit is configured to receive the offline message sent by the offline message receiving module, obtain the Email address of the user according to the user information carried in the offline message, obtain the Email address and the password of the contact according to the contact information, and send the Email address and the password to the Email obtaining unit. Specifically speaking, the contact information may be the UIN of the contact.

The Email obtaining unit is configured to receive, according to the Email address and password sent by the address and password obtaining unit, an Email, the addresser of which is the Email address of the user and the identifier of which is the Email identifier carried in the offline message.

The Email server is configured to receive the Email sent by the Email sending module, and send the Email to the Email obtaining module.

The offline message server is configured to receive the offline message sent by the offline message sending module, and send the offline message to the offline message receiving module.

The offline message server may consist of an IM server and an offline message management server, or may be implemented adopting one of the IM server and the offline message management server.

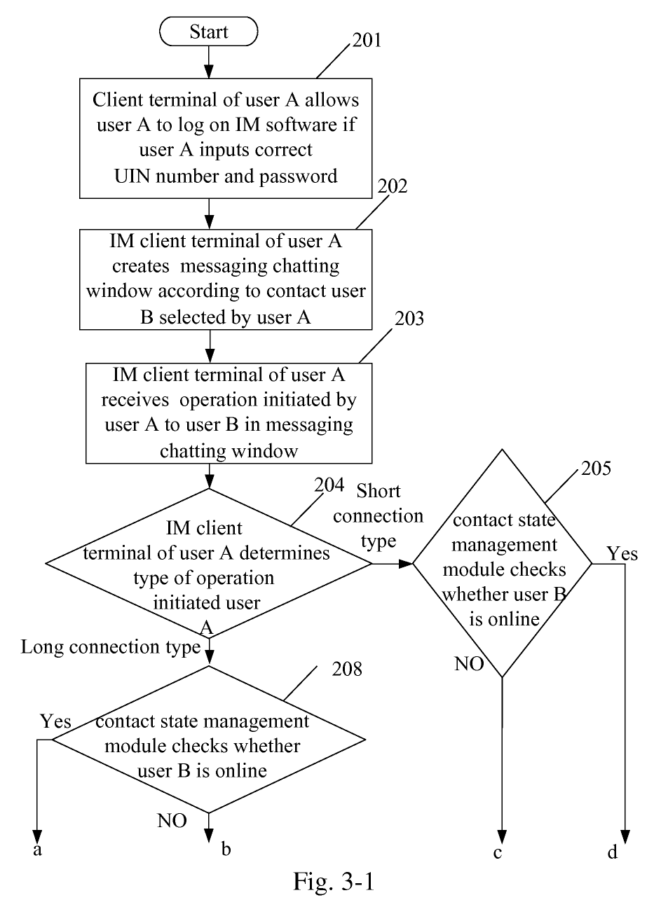

With referent to FIG. 2, the embodiment of the present disclosure provides a method for sending an offline message in an IM system. The method includes the following specific blocks.

Block 101: When a user sends data to an offline contact, an IM client terminal of the user sends the data to the contact via an Email, and sends an offline message to the contact. The offline message carries user information and an identifier of the Email.

In the embodiment of the present disclosure, the user refers to a party that sends data online, and the contact refers to the party that is offline.

Block 102: After the contact logs on, an IM client terminal of the contact receives the offline message, and receives the Email according to contents carried in the offline message.

The method for sending the data to the contact in the form of an Email may include obtaining the Email address and the password of the user according to the user information, obtaining the Email address of the contact according to the contact information, generating the Email in which the Email address of the user, the Email address of the contact and the data are respectively taken as the addresser, addressee and attachment, and sending the Email to the contact.

The method of receiving the Email according to the contents carried in the offline message may include obtaining the Email address of the user according to the user information carried in the offline message, obtaining the Email address and the password of the contact according to the contact information, and receiving the Email the addresser of which is the Email address of the user and the identifier of which is the Email identifier carried in the offline message.

The above-mentioned Email identifier may be a name or serial number of the attachment.

The above-mentioned offline message may also carry data type.

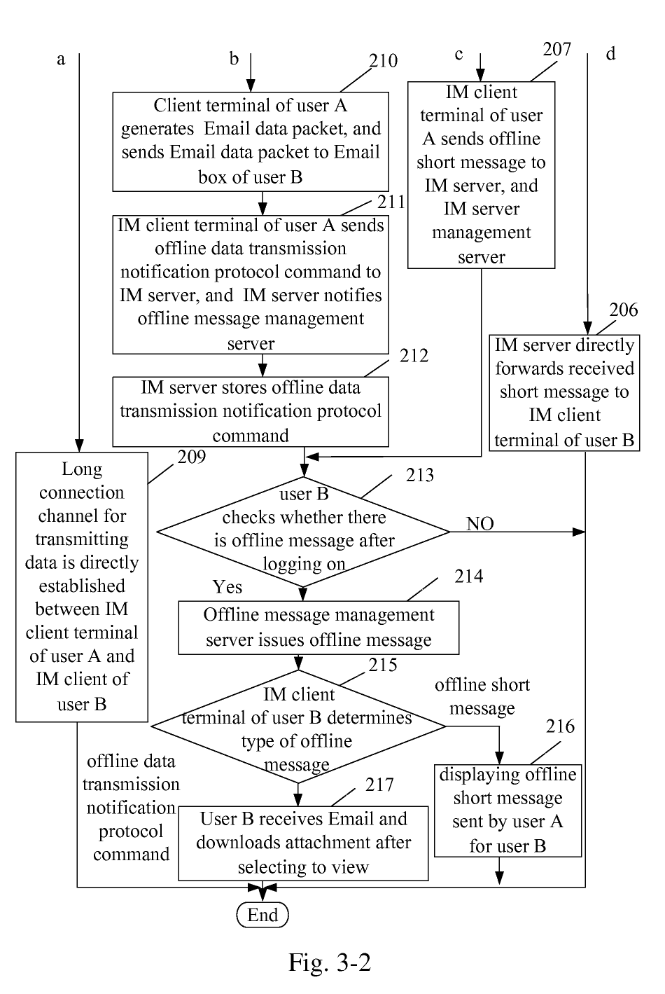

It is supposed that user A and user B are users of the IM software, are friend contacts of each other. With reference to FIG. 3, the embodiment of the present disclosure provides a method for sending an offline message in an IM system adopting the above-mentioned system. The method includes the following blocks.

Block 201: If user A inputs a correct UIN number and password, user A is allowed to log on the IM software via the IM client terminal. The specific process is as follows.

The IM client terminal generates a data packet by combining the UIN number and the password inputted by user A, and sends the data packet to the IM server. After receiving the data packet from the IM client terminal, the IM server analyzes the data packet to obtain the UIN number and the password of user A. The IM server queries a user information database, and determines whether the UIN number and the password of user A obtained by analysis are respectively consistent with the UIN number and the password of user A stored in the user information database. If they are consistent, the IM server returns a prompt message indicating that user has succeeded in logging on to the IM client terminal of user A. If they are not consistent, the IM server returns a notification message indicating that user A has failed in logging on to the IM client terminal of user A, and ends the process.

In order to ensure security, the IM client terminal may encrypt the generated data packet in advance, and then send the encrypted data packet to the IM server. After receiving the encrypted data packet, the IM server performs the decryption first, and then performs the analysis.

Block 202: After user A logging on the IM software successfully, the IM client terminal of user A creates a message chatting window according to contact user B selected by user A. The specific process is as follows.

A main panel management module of the IM client terminal of user A obtain a contact UIN number list of user A by utilizing a contact data management module of the IM software, and generate a panel item corresponding to each contact by utilizing an Application Programming Interface (API) related to Windows. User A selects and double-clicks one contact therein, e.g., a panel item of user B. The main panel management module responds to a mouse double-click message of user A, obtains the currently clicked panel item of user B according to mouse location clicked by user A, and obtains corresponding UIN number of user B according to the obtained panel item. A contact chat window management module generates a corresponding message chatting window according to the obtained UIN number of user B. The generated message chatting window is used for transmitting data, such as an IM (e.g., common text message), a data document and voice information, etc.

Block 203: The IM client terminal of user A receives an operation initiated by user A to user B in the message chatting window, e.g., sending text messages or sending data documents, etc.

Block 204: The IM client terminal of user A determines type of the operation initiated by user A, if the type is a short connection transmission type, that is, user A transmits an IM, i.e., common text message, to user B, block 205 is executed. If the type is a long connection transmission type, that is, user A sends a large data packet, e.g., document or voice information, to user B, block 208 is performed.

Block 205: A contact state management module checks state of user B according to the UIN number of user B. If the state is online, block 206 is performed; otherwise, block 207 is performed.

Block 206: The IM server directly forwards the received IM to an IM client terminal of user B, and the process is terminated.

Block 207: The IM client terminal of user A sends an offline short message to the IM server, and the IM server notifies the offline message management server, and block 213 is performed.

Block 208: The contact state management module checks the state of user B according to the UIN number of user B. If the state is online, block 209 is performed; otherwise, block 210 is performed.

Block 209: A long connection channel for transmitting data is directly established between the IM client terminal of user A and the IM client terminal of user B, and then the process is terminated.

Block 210: The IM client terminal of user A generates an Email data packet, sends the Email data packet to the Email box of user B utilizing an Email transmission channel of Simple Message Transfer Protocol (SMTP). The specific process is as follows.

The IM client terminal of user A queries the user information management module, obtains an Email address and corresponding password associated with the UIN number of user A, obtains corresponding SMTP address according to the Email address, and generates an Email data packet with the password, the SMTP address and the Email address of user A which is taken as addresser, according to SMTP protocol command and Email format. After generating the Email data packet, it is also necessary for the IM client terminal of user A to configure the data that user A wishes to transmit to user B, in the Email data packet in the form of an attachment, and configures the Email address of user B which is obtained by the contact data management module through query, in the Email data packet as the addressee.

After packing the Email data packet, the Email data packet is sent to the Email box of user B through the Email transmission channel of SMTP.

Block 211: The IM client terminal of user A sends an offline data transmission notification protocol command to the IM server. The offline data transmission notification protocol command includes the UIN number of user A, the identifier of the large data packet to be transmitted, e.g., a name or serial number. In order to enable the receiver to differentiate different data types and perform different processes for different data types, the offline data transmission notification protocol command may further include the type of the large data packet to be transmitted, e.g., voice data or image data. Thus, the voice data may be directly played, and the image data may be directly displayed. After receiving the offline data transmission notification protocol command, the IM server notifies the offline message management server. With reference to the data documents, the data may be directly written into the message body of the Email when sending the Email.

Block 212: After receiving the offline data transmission notification protocol command sent by the IM client terminal of user A, the IM server saves it into an offline notification message list corresponding to the UIN number of user B.

Block 213: After user B logging on the IM client terminal successfully, the IM state management server notifies the offline message management server. The offline message management server checks whether there is an offline message according to the UIN number of user B. If there is an offline message, block 214 is performed; otherwise, the process is terminated.

The offline message includes an offline short message and an offline data transmission notification protocol command.

Block 214: The offline message management server issues the offline message to the IM client terminal of user B according to the IP address and Port address of the Personal Computer (PC) at which the IM client terminal of user B located.

Block 215: After receiving the offline message, the IM client terminal of user B analyzes the offline message to extract the UIN number of user A, and determines the type of the offline message according to the command number in the offline message. If the offline message is the offline short message, block 216 is performed. If the offline message is the offline notification message, that is, the offline data transmission notification protocol command, block 217 is performed.

Block 216: The IM client terminal of user B directly displays the offline short message sent by user A for user B to review, and the process is terminated.

Block 217: the IM client terminal of user B asks user B whether to perform viewing and downloading operation for the actual data, receives the Email and downloads corresponding attachment after user B selecting to view, and obtains the offline data. The specific process is as follows.

After user B selecting to view, the IM client terminal of user B queries the user information management module, obtains the Email address and the password of user B according to the UIN number of user B. Meanwhile, the IM client terminal of user B queries the contact data management module, and obtains the Email address of user A according to the UIN number of user A carried in the offline data transmission notification protocol command. The IM client terminal of user B downloads Emails of which the addresser Email address is user A′s Email address, according to the Email receiving protocol of Post Office Protocol 3 (POP3) and utilizing the Email address, password and POP3 address of user B. With reference to the downloaded Emails, if user A sends multiple offline large data packets to user B, the IM client terminal of user B determines whether the name or serial number of the attachment in the Email is the name or serial number of the offline large data packet that user B currently wishes to download. If yes, the IM client terminal of user B downloads the attachment utilizing the Email receiving protocol of POP3 to the PC of user B. And then, user B may be able to review the data document or voice document sent by user A. The data document may be directly read from the message body of the Email, since the data may be written into message body of the Email when the Email is sent.

In blocks 207 and 211 of above embodiment, the offline message is sent to the offline message management server via the IM server. In block 213, when user B logs on, the offline message is further sent to the client terminal of user B by the offline message management server. When the system is relative small, the offline message may be forwarded to the client terminal of user B directly by one of the IM server and the offline message management server.

By adopting the embodiments of the present disclosure, the users may not only send and receive offline documents utilizing IM software, but also receive the offline Short Message Service (SMS) message, offline Multi Media Service (MMS) message or offline stream media video sent by the mobile terminal contacts. Besides, some offline messages of a group or a forum which exceed a certain amount and need to be discarded may be transmitted according to the above-mentioned method, and subsequently, the storage capacity of a group server may be saved. A telephone call of a contact may be sent by an Email operated by voice interactive technologies. After receiving the Email, the system reads the Email for the user using Text-to-Speech (TTS), and provides a telephone voice Email service using a telephone record. Through the conversion from a document to a fax, the users may receive common Emails using an electrograph, on the contrary, may receive faxes with an Email box.

In the embodiments of the present disclosure, the contact may receive a large amount of data, such as the offline document, offline voice messaging sent from the user through the combination of the offline message and the Email. Subsequently, advantages of the IM application and that of the Email application may be well combined, and communication among users may be greatly facilitated. Any valuable message service will not be missed by the offline users, which greatly meet the communication needs of the users and make the IM software more easy to be used.

Besides, unified messaging services, such as the Internet, traditional voice, fax, mobile message processing, IM contact information, IM group message, forum's message, voice messaging, video Email, etc, may be effectively supported utilizing the unified messaging service of Email.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for sending data in an Instant Messaging (IM) system, comprising:
sending an Email carrying a large amount of data of a first user to an offline second user;
sending an offline message to the second user, the offline message carrying information of the first user and an identifier of the Email, with which the second user obtains the large amount of data.

2. The method according to claim 1, wherein sending the Email carrying the large amount of data of the first user to the offline second user comprises:
obtaining an Email address and a password of the first user;
obtaining an Email address of the second user;
generating an Email by using the obtained Email address and the password of the first user; and
sending the generated Email to a client terminal of the second user, the Email address of the first user being an addresser Email address, the Email address of the second user being an addressee Email address, and the large amount of data being taken as an attachment.

3. The method according to claim 1, wherein
the offline message is an offline data transmission notification protocol command;
the information of the first user carried by the offline message at least comprises a User Identification Number, UIN;
the identifier of the Email carried by the offline message at least comprises one of: a name of an attachment and a serial number of the attachment.

4. The method according claim 1, wherein the large amount of data is data of at least 1 k bytes.

5. The method according to claim 3, wherein the offline message further comprises a type identifier indicating a type of the large amount of data.

6. A method for receiving data in an Instant Messaging (IM) system, comprising:
receiving, by an online first user, an offline message from a second user, the offline message carrying information of the second user and an identifier of an Email carrying a large amount of data;
receiving the Email according to the information of the second user and the identifier of the Email carried in the offline message, and
receiving the large amount of data from the Email.

7. The method according to claim 6, wherein receiving the Email according to the information of the second user and the identifier of the Email carried in the offline message comprises:
obtaining an Email address of the second user according to the information of the second user carried in the offline message;
obtaining an Email address and a password of the first user;
receiving an Email, an addresser of which is the Email address of the first user and an identifier of which is an identifier of the Email carried in the offline message.

8. The method according to claim 6, wherein the offline message further comprises a type identifier indicating a type of the large amount of data.

9. A user client terminal, comprising:
an Email sending module, configured to send an Email carrying a large amount of data of a first user to an offline second user; and
an offline message sending module, configured to send an offline message when the Email sending module is sending the Email, the offline message carrying information of the first user and an identifier of the Email, with which the second user obtains the large amount of data.

10. The user client terminal according to claim 9, further comprising:
an offline message receiving module, configured to receive a second offline message after a third user logs on, the second offline message carrying information of a fourth user sending second data and an identifier of an Email carrying the second data, and the second data being a large amount of data; and
an Email obtaining module, configured to obtain the Email carrying the second data according to user information and an identifier of the Email carried in the second offline message received by the offline message receiving module, and obtain the second data from the Email.

11. The user client terminal according to claim 9, wherein the Email sending module comprises:
an Email generating unit, configured to obtain an Email address and a password of the first user, obtain an Email address of the second user, and generate the Email taking the Email address of the first user as an addresser, taking the Email addresser of the second user as an addressee, and taking the large amount of data as an attachment; and
an Email sending unit, configured to receive the Email sent from the Email generating unit, and send the Email according to the Email address and the password of the first user, and the Email address of the second user obtained by the Email generating unit.

12. A contact client terminal, comprising:
an offline message receiving module, configured to receive an offline message after a first user client terminal logs on, the offline message carrying information of a second user and an identifier of an Email carrying a large amount of data; and
an Email obtaining module, configured to receive the offline message sent by the offline message receiving module, receive the Email carrying the large amount of data according to the information of the second user and an identifier of the Email carried in the offline message, and receive the large amount of data.

13. The contact client terminal according to claim 12, wherein the Email obtaining module comprises:
an address and password obtaining unit, configured to receive the offline message sent by the offline message receiving module, obtain an Email address of the second user according to the information of the second user carried in the offline message, and obtain an Email address and a password of the first user; and
an Email obtaining unit, configured to receive the Email, an addresser of which is the Email address of the second user and the identifier of which is the identifier of the Email carried in the offline message, according to the Email address and the password of the first user and the Email address of the second user which are sent from the address and password obtaining unit.

14. An Instant Messaging (IM) system, comprising:
a client terminal of a first user, configured to send an Email carrying a large amount of data to an offline second user, and send an offline message to the second user, the offline message carrying information of the first user and an identifier of the Email; and
a client terminal of the second user, configured to receive the offline message from the client terminal of the first user when the second user logs on, and receive the Email according to the information of the first user and the identifier of the Email carried in the offline message.

15. An Instant Messaging (IM) method, comprising:
sending, by a client terminal of a first user, an Email carrying a large amount of data to an offline second user, and sending an offline message to the second user, the offline message carrying information of the first user and an identifier of the Email; and
receiving, by a client terminal of the second user, the offline message from the first user client terminal when the second user logs on, and receiving the Email according to the information of the first user and the identifier of the Email carried in the offline message.
